(19) United States
(12) Patent Application Publication
(10) Pub. No.: US 2026/0232161 A1
(43) Pub. Date: Aug. 13, 2026

(54) CONTROL METHOD AND APPARATUS FOR SELF-CLEANING MAINTENANCE STATION, AND DEVICE AND MEDIUM

(71) Applicant: Beijing Roborock Innovation Technology Co., Ltd., Beijing (CN)

(72) Inventor: Ran CHENG, Beijing (CN)

(73) Assignee: Beijing Roborock Innovation Technology Co., Ltd., Beijing (CN)

(21) Appl. No.: 19/154,366

(22) PCT Filed: Jan. 29, 2024
(86) PCT No.: PCT/CN2024/074530

§ 371 Date: Aug. 6, 2025

(30) Foreign Application Priority Data
Feb. 8, 2023 (CN) 202310116010.0

(51) Int. Cl. A47L 11/40; A47L 9/00

(52) U.S. Cl. CPC A47L 11/4083; A47L 9/0063; A47L 11/4025; A47L 11/4091; A47L 2201/024; A47L 2201/026

(57) ABSTRACT

A method for controlling a self-cleaning maintenance station, includes: acquiring a self-cleaning maintenance station emptying instruction triggered by a user, and stopping injecting clean water into the clean water tank; and executing a drainage operation instruction within a first preset time range, where the drainage operation instruction includes: causing a clean water pump to pump the clean water from the clean water tank to the cleaning tank, causing a wastewater pump to pump wastewater from the cleaning tank to the wastewater tank, and causing a drainage pump to drain the wastewater from the wastewater tank by a drainage pump.

### CROSS-REFERENCE TO RELATED APPLICATIONS

The present application is a U.S. national stage of International Patent Application No. PCT/CN2024/074530, and claims priority to Chinese Patent Application No. 202310116010.0 filed on Feb. 8, 2023, the disclosure of both of which is incorporated herein by reference in their entirety as a part of the present disclosure.

### TECHNICAL FIELD

The present disclosure relates to the field of robot technology, and in particular, to a method and apparatus for controlling a self-cleaning maintenance station, a device, and a medium.

### BACKGROUND

In recent years, automatic cleaning devices and self-cleaning maintenance stations used in combination with the automatic cleaning device have been more and more widely used, which provides great convenience for people's lives. The self-cleaning maintenance station can automatically replenish the automatic cleaning device with clean water, wash the mopping cloth, suction wastewater, collect dust, etc.

After a smart water-supplying and draining kit is installed, the self-cleaning maintenance station can automatically supply and drain water, and the user does not need to manually change the water, such that the automatic cleaning device can be used more easily. However, when the user needs to pack or carry the kit, it is necessary to empty the residual water inside to avoid damage to the product due to water leakage during transportation. Therefore, how to conveniently drain the residual water in the self-cleaning maintenance station is an urgent technical problem to be solved.

### SUMMARY

In view of this, embodiments of the present disclosure provide a method and apparatus for controlling a self-cleaning maintenance station, a device, and a medium, so as to solve the technical problem of residual water drainage in the self-cleaning maintenance station. In a first aspect, the embodiments of the present disclosure provide a method for controlling a self-cleaning maintenance station, where the self-cleaning maintenance station includes a clean water tank, a wastewater tank, and a cleaning tank, and the method includes:
acquiring a self-cleaning maintenance station emptying instruction triggered by a user, and stopping injecting clean water into the clean water tank; and
executing a drainage operation instruction within a first preset time range, where the drainage operation instruction includes: pumping the clean water from the clean water tank to the cleaning tank by a clean water pump, pumping wastewater from the cleaning tank to the wastewater tank by a wastewater pump, and draining the wastewater from the wastewater tank by a drainage pump.

In some embodiments, the method further includes:
stopping the clean water pump from pumping the water from the clean water tank and stopping the wastewater pump from suctioning the wastewater from the cleaning tank if a wastewater tank full instruction is triggered within the first preset time range; and
continuing to drain the wastewater from the wastewater tank by the drainage pump within a second preset time range.

In some embodiments, after continuing to drain the wastewater from the wastewater tank by the drainage pump within the second preset time range, the method further includes:
continuing to execute the drainage operation instruction if the wastewater tank full instruction is not triggered; and
giving a wastewater tank error instruction if the wastewater tank full instruction is still triggered.

In some embodiments, the method further includes:
stopping the clean water pump from pumping the water from the clean water tank if a cleaning tank full instruction is triggered within the first preset time range; and
continuing to suction the wastewater from the cleaning tank by the wastewater pump and continuing to drain the wastewater from the wastewater tank by the drainage pump within a third preset time range.

In some embodiments, after continuing to suction the wastewater from the cleaning tank by the wastewater pump and continuing to drain the wastewater from the wastewater tank by the drainage pump within the third preset time range, the method further includes:
continuing to execute the drainage operation instruction if the cleaning tank full instruction is not triggered; and
giving a cleaning tank error instruction if the cleaning tank full instruction is still triggered.

In some embodiments, the method further includes:
giving a clean water tank error instruction if a clean water tank full instruction is triggered after the first preset time.

In some embodiments, after executing the drainage operation instruction within the first preset time range, the method further includes:
executing an emptying operation instruction within a fourth preset time range, where the emptying operation instruction includes: stopping a clean water pumping operation of the clean water pump, stopping a wastewater suctioning operation of the wastewater pump, and
continuing to drain the wastewater from the wastewater tank by the drainage pump.

In a second aspect, the embodiments of the present disclosure provide an apparatus for controlling a self-cleaning maintenance station, where the self-cleaning maintenance station includes a clean water tank, a wastewater tank, and a cleaning tank, and the apparatus includes:
an acquiring unit, configured to acquire a self-cleaning maintenance station emptying instruction triggered by a user, and stop injecting clean water into the clean water tank; and
an execution unit, configured to execute a drainage operation instruction within a first preset time range, where the drainage operation instruction includes: pumping the clean water from the clean water tank to the cleaning tank by a clean water pump, pumping wastewater from the cleaning tank to the wastewater tank by a wastewater pump, and draining the wastewater from the wastewater tank by a drainage pump.

In a third aspect, the embodiments of the present disclosure provide a self-cleaning maintenance station, which includes a processor and a memory, where the memory stores computer program instructions executable by the processor, and the processor, when executing the computer program instructions, is caused to perform steps of the method according to any one of the above embodiments.

In a fourth aspect, the embodiments of the present disclosure provide a non-transitory computer-readable storage medium storing computer program instructions, where the computer program instructions, when loaded and executed by a processor, cause the processor to perform steps of the method according to any one of the above embodiments.

Compared with the related art, the present disclosure has at least the following technical effects:

According to the method for controlling a self-cleaning maintenance station provided by the embodiments of the present disclosure, the user only needs to send the self-cleaning maintenance station emptying instruction, for example, through a mobile phone APP or a touch button, the self-cleaning maintenance station can complete the drainage operation instruction and the emptying operation instruction within the preset time range, and can automatically complete the detection and troubleshooting functions according to respective emergencies during the execution of the drainage operation instruction and the emptying operation instruction, such that the self-cleaning maintenance station can automatically empty the residual water, meeting the requirements of box packing and transportation, and improving the user experience.

### BRIEF DESCRIPTION OF THE DRAWINGS

For a clearer illustration of the technical solutions in the embodiments of the present disclosure or in the related art, the drawings that need to be used in the description of the embodiments or the related art are briefly introduced below. Apparently, the drawings in the following description are some embodiments of the present disclosure, and those of ordinary skill in the art may still derive other drawings from these drawings without creative efforts.

FIG. 1 is a perspective structural diagram of a self-cleaning maintenance station according to some embodiments of the present disclosure;

FIG. 2 is a schematic structural diagram of a water circuit of a self-cleaning maintenance station according to some embodiments of the present disclosure;

FIG. 3 is a schematic flowchart of a method for controlling a self-cleaning maintenance station according to some embodiments of the present disclosure;

FIG. 4 is a schematic flowchart of a method for controlling a self-cleaning maintenance station according to some embodiments of the present disclosure;

FIG. 5 is a schematic flowchart of a method for controlling a self-cleaning maintenance station according to some embodiments of the present disclosure;

FIG. 6 is a schematic flowchart of a method for controlling a self-cleaning maintenance station according to some embodiments of the present disclosure;

FIG. 7 is a schematic flowchart of a method for controlling a self-cleaning maintenance station according to some embodiments of the present disclosure;

FIG. 8 is a schematic structural diagram of an apparatus for controlling a self-cleaning maintenance station according to some embodiments of the present disclosure;

FIG. 9 is a schematic structural diagram of an apparatus for controlling a self-cleaning maintenance station according to some embodiments of the present disclosure;

FIG. 10 is a schematic structural diagram of an apparatus for controlling a self-cleaning maintenance station according to some embodiments of the present disclosure;

FIG. 11 is a schematic structural diagram of an apparatus for controlling a self-cleaning maintenance station according to some embodiments of the present disclosure;

FIG. 12 is a schematic structural diagram of an apparatus for controlling a self-cleaning maintenance station according to some embodiments of the present disclosure; and

FIG. 13 is a schematic diagram of an electronic structure of a robot according to some embodiments of the present disclosure.

### DETAILED DESCRIPTION

For clearer descriptions of the objectives, technical solutions, and advantages of the present disclosure, the present disclosure is further described in detail hereinafter with reference to the accompanying drawings. Apparently, the described embodiments are merely some embodiments of the present disclosure, rather than all of the embodiments. Based on the embodiments in the present disclosure, all other embodiments obtained by those of ordinary skill in the art without creative efforts shall fall within the protection scope of the present disclosure.

The terms used in the embodiments of the present disclosure are for the purpose of describing particular embodiments only and are not intended to be limiting to the present disclosure. As used in the embodiments and the appended claims of the present disclosure, the singular forms “a”, “an”, and “the” are intended to include the plural forms as well, unless the context clearly indicates otherwise, and “a plurality of” generally includes at least two.

It should be understood that the term “and/or” as used herein is merely a description of an association relationship between associated objects, indicating that three possible relationships may exist. For example, “A and/or B” can represent: the existence of A alone, the simultaneous existence of A and B, and the existence of B alone. In addition, the character “/” herein generally indicates an “or” relationship between the associated objects before and after.

It should be further noted that the terms “comprise”, “include”, or any other variation thereof, are intended to encompass a non-exclusive inclusion, such that a commodity or an apparatus including a list of elements includes not only those elements, but also other elements not explicitly listed or inherent to such commodity or apparatus. Without further limitation, an element defined by the phrase “comprising a/an ... ” or “including a/an ... ” does not exclude the presence of other identical elements in the commodity or apparatus including the element.

Embodiments of the present disclosure will be described in detail hereinafter with reference to the accompanying drawings.

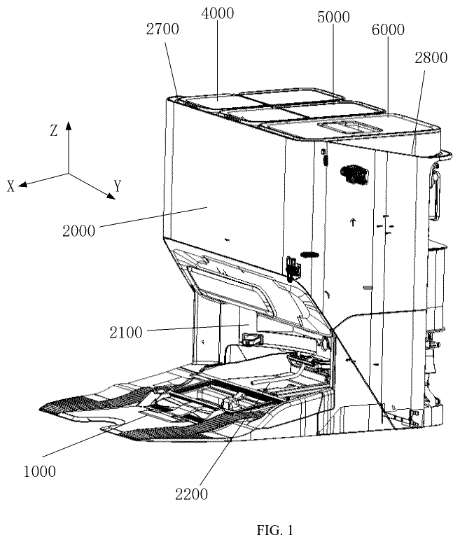

The embodiments of the present disclosure provide a method for controlling a self-cleaning maintenance station. As an example, FIG. 1 is a schematic diagram of an overall structure of a self-cleaning maintenance station for implementing the method. The structure of the self-cleaning maintenance station is only for the convenience of understanding the method for controlling the self-cleaning maintenance station, and has no substantial limitation on the control method. That is, the control method is applicable to a self-cleaning maintenance station of any other corresponding structure.

For a clearer description of the behavior of the self-cleaning maintenance station, the directions are defined as follows: the self-cleaning maintenance station can be calibrated by defining the following three mutually perpendicular axes: a transverse axis Y, a front-rear axis X, and a central vertical axis Z. A direction opposite to an arrow along the front-rear axis X, that is, a direction where the automatic cleaning device enters the self-cleaning maintenance station, is marked as “rearward”, and a direction along the front-rear axis X, that is, a direction where the automatic cleaning device leaves the self-cleaning and maintenance station, is marked as “forward”. The transverse axis Y is substantially along the direction of the width of the self-cleaning maintenance station body. The direction of the arrow along the transverse axis Y is the “left side” of the self-cleaning maintenance station, and the opposite direction of the arrow along the transverse axis Y is the “right side” of the self-cleaning maintenance station. The vertical axis Z is a direction extending upward along the bottom surface of the self-cleaning maintenance station, a direction of an arrow along the vertical axis Z is an “upper side” of the self-cleaning maintenance station, and an opposite direction of the arrow along the vertical axis Z is a “lower side” of the self-cleaning maintenance station.

As shown in FIG. 1, the self-cleaning maintenance station provided by this embodiment includes a self-cleaning maintenance station bottom plate 1000 and a self-cleaning maintenance station body 2000, where the self-cleaning maintenance station bottom plate 1000 is detachably or non-detachably connected to the self-cleaning maintenance station body 2000. The detachable connection facilitates the transportation and maintenance of the self-cleaning maintenance station bottom plate 1000 and the self-cleaning maintenance station main body 2000.

The self-cleaning maintenance station body 2000 includes a water storage cavity 2700 and a dust collection cavity 2800. The water storage cavity 2700 is disposed at the top of the self-cleaning maintenance station body 2000 with an opening facing upward. The water storage cavity 2700 is configured to accommodate the clean water tank 4000 and the wastewater tank 5000. The dust collection cavity 2800 is disposed at the top end of the self-cleaning maintenance station body 2000 side by side with the water storage cavity 2700 with an opening facing upward. The dust collection cavity 2800 is configured to accommodate a dust collection cover 6000, and the clean water tank 4000, the wastewater tank 5000 and the dust collection cover 6000 are assembled on the self-cleaning maintenance station body 2000. For example, the clean water tank 4000, the wastewater tank 5000 and the dust collection cover 6000 may be integrally installed with the self-cleaning maintenance station body 2000, such that the configuration is neat in appearance and convenient for transportation.

The lower portion of the self-cleaning maintenance station body 2000 and the self-cleaning maintenance station bottom plate 1000 jointly form a cleaning cavity 2100 with an opening forward. The cleaning cavity 2100 is configured to accommodate the automatic cleaning device when the automatic cleaning device returns to the self-cleaning maintenance station for maintenance. The self-cleaning maintenance station main body is provided with a cleaning tank 2200 at the bottom, and is configured to clean a cleaning component, such as a mop, on the automatic cleaning device through the cleaning tank 2200 after the automatic cleaning device is fitted into the cleaning cavity 2100.

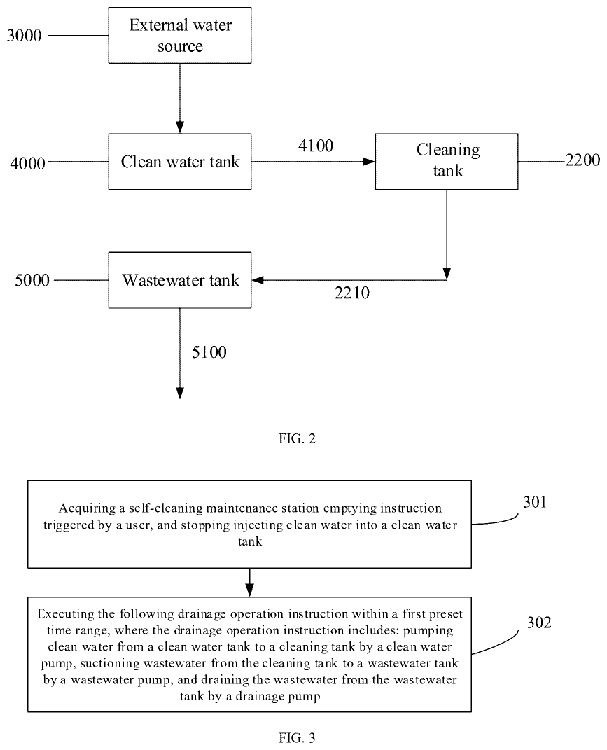

A water supply and drainage process of the self-cleaning maintenance station is shown in FIG. 2. The self-cleaning maintenance station controls an external water source 3000 through an automatic water supply system, for example, is connected to tap water to add clean water to the clean water tank 4000, and a full-level sensor is arranged in the clean water tank 4000. When the clean water tank 4000 is full of water, the water supply to the clean water tank 4000 is stopped, and when the water level of the clean water tank 4000 drops to a preset position, the water is automatically supplied to the clean water tank 4000. The water in the clean water tank 4000 is supplied to the cleaning tank 2200 by the clean water pump 4100, the automatic cleaning device cleans the mop in the cleaning tank 2200, and then the wastewater in the cleaning tank 2200 is suctioned to the wastewater tank 5000 by the wastewater pump 2210. A wastewater sensor is arranged in the wastewater tank 5000. When the wastewater tank 5000 is full of water, suctioning of wastewater by the wastewater pump 2210 is stopped, and the wastewater in the wastewater tank 5000 is drained out of the wastewater tank by the drainage pump 5100.

As described above, during the normal operation of the self-cleaning maintenance station, at least partial residual water exists in the water circuit (such as the clean water tank 4000, the wastewater tank 5000, the cleaning tank 2200 or the pipeline) of the self-cleaning maintenance station. When the user needs to pack or carry the kit, it is necessary to empty the residual water inside to avoid damage to the product due to water leakage during transportation.

Based on this, the embodiments of the present disclosure provide a method for controlling a self-cleaning maintenance station. The method includes: acquiring a self-cleaning maintenance station emptying instruction triggered by a user, and stopping injecting clean water into a clean water tank; and executing a drainage operation instruction within a first preset time range, where the drainage operation instruction includes: pumping the clean water from the clean water tank to a cleaning tank by a clean water pump, suctioning wastewater from the cleaning tank to a wastewater tank by a wastewater pump, and draining the wastewater from the wastewater tank by the drainage pump.

According to the method for controlling a self-cleaning maintenance station provided by the embodiments of the present disclosure, the user only needs to send the self-cleaning maintenance station emptying instruction, for example, through a mobile phone APP or a touch button, the self-cleaning maintenance station can complete the drainage operation instruction and the emptying operation instruction within the preset time range, and can automatically complete the detection and troubleshooting functions according to respective emergencies during the execution of the drainage operation instruction and the emptying operation instruction, such that the self-cleaning maintenance station can automatically empty the residual water, meeting the requirements of box packing and transportation, and improving the user experience.

As shown in FIG. 3, the embodiments of the present disclosure provide a method for controlling a self-cleaning maintenance station, where the self-cleaning maintenance station includes a clean water tank, a wastewater tank, and a cleaning tank, and the method includes the following method steps:
step S301: acquiring a self-cleaning maintenance station emptying instruction triggered by a user, and stopping injecting clean water into the clean water tank; and
step S302: executing a drainage operation instruction within a first preset time range, where the drainage operation instruction includes: pumping the clean water from the clean water tank to the cleaning tank by a clean water pump, pumping wastewater from the cleaning tank to the wastewater tank by a wastewater pump, and draining the wastewater from the wastewater tank by a drainage pump.

In step S301, the user may send the self-cleaning maintenance station emptying instruction through a mobile phone APP. For example, a “one-click emptying” button is set in the mobile phone APP. After clicking the “one-click emptying” button, the user sends the self-cleaning maintenance station emptying instruction to the self-cleaning maintenance station through the mobile phone wireless communication. After receiving the self-cleaning maintenance station emptying instruction, the self-cleaning maintenance station starts to perform the operation of emptying the residual water from the self-cleaning maintenance station. The user may also send an emptying instruction through an emptying button on the self-cleaning maintenance station, and after receiving the self-cleaning maintenance station emptying instruction, the self-cleaning maintenance station starts to perform the operation of emptying the residual water from the self-cleaning maintenance station. The operation of emptying the residual water to be first performed by the self-cleaning maintenance station is to stop injecting clean water into the clean water tank and cut off the source, so as to perform the subsequent operation of emptying the residual water.

In step S302, the self-cleaning maintenance station executes the drainage operation instruction within the first preset time range. The first preset time is a time obtained through a plurality of repeated operations in an experiment. For example, when the clean water tank, the wastewater tank, and the cleaning tank are all full, a proper first preset time is set after a plurality of experiments to empty the clean water tank, the wastewater tank, and the cleaning tank. The first preset time may be an average value, a maximum value, or a normal distribution value of a plurality of experiments, or may be a value obtained by multiplying the average value, the maximum value, or the normal distribution value by a coefficient, where the coefficient may be 1.2 to 1.5, to ensure sufficient time for drainage within the first preset time range. Where the drainage operation instruction includes: pumping the clean water from the clean water tank to the cleaning tank by a clean water pump, pumping wastewater from the cleaning tank to the wastewater tank by a wastewater pump, and draining the wastewater from the wastewater tank by the drainage pump. That is, when the drainage operation instruction is executed, the clean water pump, the wastewater pump, and the drainage pump all work normally, such that the residual water flows out of the self-cleaning maintenance station in the flow direction shown by the arrow in FIG. 2.

In some embodiments, as shown in FIG. 4, in order to prevent unexpected failures in the drainage process and improve the accuracy and the drainage efficiency of emptying the residual water, the method further includes the following steps:
step S303: stopping the clean water pump from pumping the water from the clean water tank and stopping the wastewater pump from suctioning wastewater from the cleaning tank if a wastewater tank full instruction is triggered within the first preset time range; and
step S304: continuing to drain the wastewater from the wastewater tank by the drainage pump within a second preset time range.

In step S303, within the first preset time range described above, in a process of executing the drainage operation instruction by the self-cleaning maintenance station, if the wastewater tank full instruction is triggered, for example, when the Hall element senses that the water level of the wastewater tank has reached the maximum limit, the clean water pump is stopped by the control system from pumping the water from the clean water tank to the cleaning tank. Since it is impossible to store more wastewater after the wastewater tank in the water circuit is full, the wastewater pump has to be stopped from suctioning the wastewater from the cleaning tank, otherwise the wastewater overflows. At the same time, the flow of clean water into the cleaning tank has to be stopped, otherwise the water in the cleaning tank will also overflow.

In step S304, after step S303 is performed, the wastewater continues to be drained from the wastewater tank by the drainage pump within the second preset time range. The second preset time is also data obtained in advance through a plurality of experiments, for example, a time required to empty a full wastewater tank. A proper second preset time is set after the plurality of experiments. The second preset time may be an average value, a maximum value, or a normal distribution value of the plurality of experiments, or may be a value obtained by multiplying the average value, the maximum value, or the normal distribution value by a coefficient, where the coefficient may be 0.5 to 1.2, to ensure sufficient space for the wastewater tank to accommodate the wastewater again after the second preset time is completed. It can be understood that, after the second preset time is completed, the wastewater tank may be empty or may retain some wastewater.

In some embodiments, as shown in FIG. 5, in order to prevent unexpected failures in the drainage process and improve the accuracy and the drainage efficiency of emptying the residual water, after continuing to drain the wastewater from the wastewater tank by the drainage pump within the second preset time range, the method further includes the following steps:
step S304-1: continuing to execute the drainage operation instruction if the wastewater tank full instruction is not triggered; and
step S304-2: giving a wastewater tank error instruction if the wastewater tank full instruction is still triggered.

In step S304-1, after the second preset time elapses and at least a portion of the wastewater is drained from the wastewater tank by the drainage pump, if the wastewater tank full instruction is not triggered, it indicates that the wastewater tank has sufficient space to accommodate the newly suctioned wastewater, the drainage operation instruction continues to be executed, and the entire drainage process may continue to be performed cyclically.

In step S304-2, after the second preset time elapses and at least a portion of the wastewater is drained from the wastewater tank by the drainage pump, if the wastewater tank full instruction is still triggered, it indicates that a wastewater tank full-level sensor may be faulty, and the self-cleaning maintenance station should give the wastewater tank error instruction for maintenance by the user.

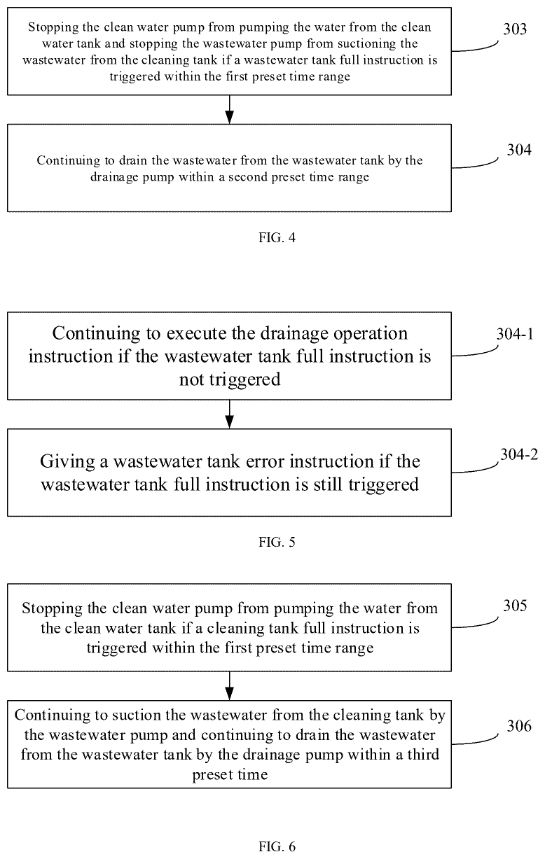

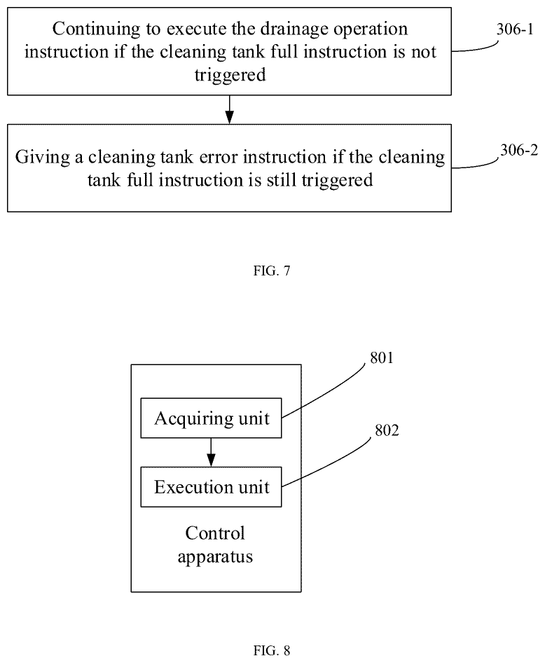

In some embodiments, as shown in FIG. 6, in order to prevent unexpected failures in the drainage process and improve the accuracy and the drainage efficiency of emptying the residual water, the method further includes the following steps:
step S305: stopping the clean water pump from pumping the water from the clean water tank if a cleaning tank full instruction is triggered within the first preset time range; and
step S306: continuing to suction the wastewater from the cleaning tank by the wastewater pump and continuing to drain the wastewater from the wastewater tank by the drainage pump within a third preset time range.

In step S305, within the first preset time range described above, in a process of executing the drainage operation instruction by the self-cleaning maintenance station, if the cleaning tank full instruction is triggered, for example, when the Hall element or a photoelectric sensor senses that the water level of the cleaning tank has reached the maximum limit, the clean water pump is stopped by the control system from pumping the water from the clean water tank to the cleaning tank since it is impossible to store more wastewater after the cleaning tank in the water circuit is full. In this case, the flow of clean water into the cleaning tank has to be stopped, otherwise the water in the cleaning tank will overflow.

In step S306, after step S305 is performed, the wastewater continues to be suctioned from the cleaning tank by the wastewater pump within the third preset time range. The third preset time is also data obtained in advance through a plurality of experiments, for example, a time required to empty a full cleaning tank. A proper third preset time is set after the plurality of experiments. The third preset time may be an average value, a maximum value, or a normal distribution value of the plurality of experiments, or may be a value obtained by multiplying the average value, the maximum value, or the normal distribution value by a coefficient, where the coefficient may be 0.5 to 1.2, to ensure sufficient space for the cleaning tank to accommodate the clean water again after the third preset time is completed. It can be understood that, after the third preset time is completed, the cleaning tank may be empty or may retain some clean water or wastewater.

In some embodiments, as shown in FIG. 7, in order to prevent unexpected failures in the drainage process and improve the accuracy and the drainage efficiency of emptying the residual water, after continuing to suction the wastewater from the cleaning tank by the wastewater pump and continuing to drain the wastewater from the wastewater tank by the drainage pump within the third preset time range, the method further includes:
step S306-1: continuing to execute the drainage operation instruction if the cleaning tank full instruction is not triggered; and
step S306-2: giving a cleaning tank error instruction if the cleaning tank full instruction is still triggered.

In step S306-1, after the third preset time elapses and at least a portion of the clean water or the wastewater is suctioned from the cleaning tank by the wastewater pump, if the cleaning tank full instruction is not triggered, it indicates that the cleaning tank has sufficient space to accommodate new clean water, the drainage operation instruction continues to be executed, and the entire drainage process may continue to be performed cyclically.

In step S306-2, after the third preset time elapses and at least a portion of the clean water or the wastewater is suctioned from the cleaning tank by the wastewater pump, if the cleaning tank full instruction is still triggered, it indicates that a cleaning tank full-level sensor may be faulty, and the self-cleaning maintenance station should give the cleaning tank error instruction for maintenance by the user.

In some embodiments, in order to prevent unexpected failures in the drainage process and improve the accuracy and the drainage efficiency of emptying the residual water, the method further includes the following step: giving a clean water tank error instruction if a clean water tank full instruction is triggered after the first preset time.

In this case, after executing the drainage operation instruction for a period of time, the clean water tank full instruction is triggered. In one case, a clean water tank full-level element, such as the Hall element, may be faulty. In another case, in step S301, the injection of the clean water into the clean water tank is not stopped, a water inlet valve is faulty, and the self-cleaning maintenance station should give the clean water tank error instruction for maintenance by the user.

In some embodiments, in order to prevent unexpected failures in the drainage process and improve the accuracy and the drainage efficiency of emptying the residual water, after executing the drainage operation instruction within the first preset time range, the method further includes the following step: executing an emptying operation instruction within a fourth preset time range, where the emptying operation instruction includes: stopping a clean water pumping operation of the clean water pump, stopping a wastewater suctioning operation of the wastewater pump, and continuing to drain the wastewater from the wastewater tank by the drainage pump.

The water may not be completely drained from the water circuit according to the drainage operation instruction executed all the time within the first preset time in step S302. In this case, an additional time should be given, such as a fourth preset time, and the emptying operation instruction is executed within the fourth preset time range, where the emptying operation instruction includes: stopping the clean water pumping operation of the clean water pump, indicating that the clean water tank should be empty; stopping the wastewater suctioning operation of the wastewater pump, indicating that the cleaning tank should be empty, but there may still be residual wastewater in the pipeline from the cleaning tank to the wastewater tank or in a water outlet pipeline of the wastewater tank. The purpose of complete emptying is achieved by continuing to drain the residual wastewater from the wastewater tank by the drainage pump.

According to the method for controlling a self-cleaning maintenance station provided by the embodiments of the present disclosure, the user only needs to send the self-cleaning maintenance station emptying instruction, for example, through a mobile phone APP or a touch button, the self-cleaning maintenance station can complete the drainage operation instruction and the emptying operation instruction within the preset time range, and can automatically complete the detection and troubleshooting functions according to respective emergencies during the execution of the drainage operation instruction and the emptying operation instruction, such that the self-cleaning maintenance station can automatically empty the residual water, meeting the requirements of box packing and transportation. The whole process is easy to operate, and the user experience is improved.

The embodiments of the present disclosure provide an apparatus for controlling a self-cleaning maintenance station configured to perform the steps of the method for controlling the self-cleaning maintenance station described above, and the same technical features have the same or similar technical effects, which will not be repeated herein. The self-cleaning maintenance station includes a clean water tank, a wastewater tank, and a cleaning tank. As shown in FIG. 8, the control apparatus includes: an acquiring unit 801, configured to acquire a self-cleaning maintenance station emptying instruction triggered by a user, and stop injecting clean water into the clean water tank; and an execution unit 802, configured to execute a drainage operation instruction within a first preset time range, where the drainage operation instruction includes: pumping the clean water from the clean water tank to the cleaning tank by a clean water pump, pumping wastewater from the cleaning tank to the wastewater tank by a wastewater pump, and draining the wastewater from the wastewater tank by a drainage pump.

In some embodiments, as shown in FIG. 9, the control apparatus further includes:
a first control unit 803, configured to stop the clean water pump from pumping the water from the clean water tank and stop the wastewater pump from suctioning the wastewater from the cleaning tank if a wastewater tank full instruction is triggered within the first preset time range; and
a second control unit 804, configured to continue to drain the wastewater from the wastewater tank by the drainage pump within a second preset time range.

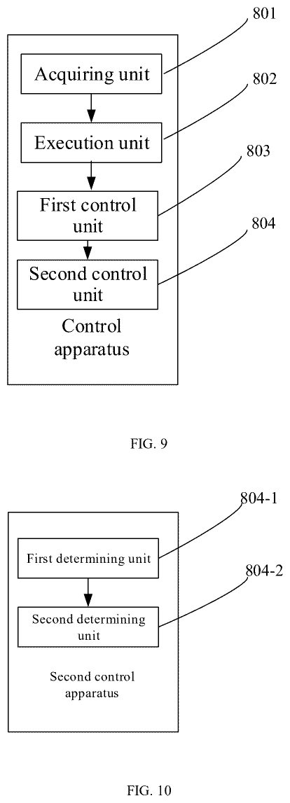

In some embodiments, as shown in FIG. 10, the second control unit 804 further includes:
a first determining unit 804-1, configured to continue to execute the drainage operation instruction if the wastewater tank full instruction is not triggered; and
a second determining unit 804-2, configured to give a wastewater tank error instruction if the wastewater tank full instruction is still triggered.

In some embodiments, as shown in FIG. 11, the control apparatus further includes:
a third control unit 805, configured to stop the clean water pump from pumping the water from the clean water tank if a cleaning tank full instruction is triggered within the first preset time range; and
a fourth control unit 806, configured to continue to suction the wastewater from the cleaning tank by the wastewater pump and continue to drain the wastewater from the wastewater tank by the drainage pump within a third preset time.

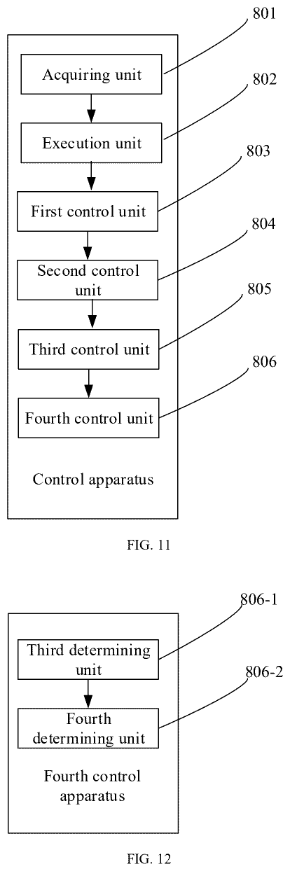

In some embodiments, as shown in FIG. 12, the fourth control unit 806 further includes:
a third determining unit 806-1, configured to continue to execute the drainage operation instruction if the cleaning tank full instruction is not triggered; and
a fourth determining unit 806-2, configured to give a cleaning tank error instruction if the cleaning tank full instruction is still triggered.

In some embodiments, the first execution unit 802 is further configured to give a clean water tank error instruction if the clean water tank full instruction is triggered after the first preset time.

In some embodiments, the first execution unit 802 is further configured to execute an emptying operation instruction within a fourth preset time range, where the emptying operation instruction includes: stopping a clean water pumping operation of the clean water pump, stopping a wastewater suctioning operation of the wastewater pump, and continuing to drain the wastewater from the wastewater tank by the drainage pump.

According to the apparatus for controlling a self-cleaning maintenance station provided by the embodiments of the present disclosure, the user only needs to send the self-cleaning maintenance station emptying instruction, for example, through a mobile phone APP or a touch button, the self-cleaning maintenance station can complete the drainage operation instruction and the emptying operation instruction within the preset time range, and can automatically complete the detection and troubleshooting functions according to respective emergencies during the execution of the drainage operation instruction and the emptying operation instruction, such that the self-cleaning maintenance station can automatically empty the residual water, meeting the requirements of box packing and transportation. The whole process is easy to operate, and the user experience is improved.

The embodiments of the present disclosure provide a non-transitory computer-readable storage medium storing computer program instructions, where the computer program instructions, when loaded and executed by a processor, cause the processor to perform the steps of the method according to any one of the above embodiments.

The embodiments of the present disclosure provide a self-cleaning maintenance station, which includes a processor and a memory, where the memory stores computer program instructions executable by the processor, and the processor, when executing the computer program instructions, is caused to perform the steps of the method according to any one of the above embodiments.

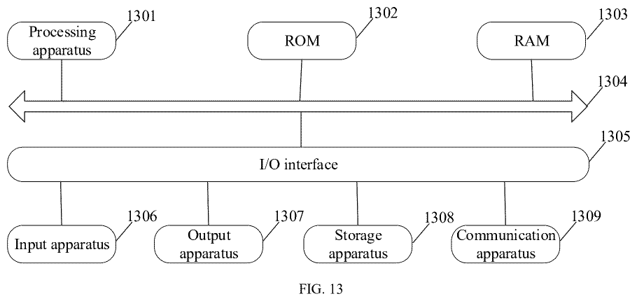

As shown in FIG. 13, the self-cleaning maintenance station may include a processing apparatus (such as a central processing unit or a graphics processing unit) 1301. The processing apparatus may perform various appropriate actions and processing according to a program stored in a read-only memory (ROM) 1302 or a program loaded from a storage apparatus 1308 into a random access memory (RAM) 1303. In the RAM 1303, various programs and data required for the operation of the self-cleaning maintenance station are also stored. The processing apparatus 1301, the ROM 1302, and the RAM 1303 are connected to each other via a bus 1304. An input/output (I/O) interface 1305 is also connected to the bus 1304.

Generally, the following apparatuses may be connected to the I/O interface 1305: an input apparatus 1306 including, for example, a touch screen, a touch pad, a keyboard, a mouse, a camera, a microphone, an accelerometer, or a gyroscope; an output apparatus 1307 including, for example, a liquid crystal display (LCD), a speaker, or a vibrator; a storage apparatus 1308 including, for example, a hard disk; and a communication apparatus 1309. The communication apparatus 1309 may allow an electronic device to perform wireless or wired communication with other devices to exchange data. Although FIG. 13 shows an electronic device equipped with various apparatuses, it should be understood that it is not required to implement or provide all the shown apparatuses, and more or fewer apparatuses may be alternatively implemented or provided.

The flowcharts and block diagrams in the accompanying drawings illustrate the architecture, functionality, and operations that can be implemented for the system, method, and computer program product according to various embodiments of the present disclosure. In this regard, each block in the flowcharts or block diagrams may represent a module, a program segment, or a portion of code, which includes one or more executable instructions configured to implement specific logical functions. It should also be noted that in some alternate implementations, functions noted in the blocks may occur in different orders than noted in the accompanying drawings. For example, two blocks shown consecutively can actually execute in parallel, or sometimes, in the reverse order, depending on the functionality involved. Also, it should be noted that each block in the block diagrams and/or flowcharts, and the combination of blocks in the block diagrams and/or flowcharts, can be implemented using a specialized hardware-based system performing the specified functions or operations, or a combination of specialized hardware and computer instructions.

Finally, it should be noted that the embodiments in the specification are described in a progressive manner, and each embodiment focuses on differences from other embodiments, and reference should be made to each other for the same or similar parts. Since the system or apparatus disclosed in the embodiments corresponds to the method disclosed in the embodiments, the description is relatively simple, and reference may be made to the description of the method part.

The above embodiments are only used to illustrate the technical solutions of the present disclosure, but not to limit them; although the present disclosure has been described in detail with reference to the foregoing embodiments, those of ordinary skill in the art should understand that they can still modify the technical solutions recorded in the foregoing embodiments, or make equivalent substitutions for some of the technical features; and these modifications or substitutions do not make the essence of the corresponding technical solutions deviate from the spirit and scope of the technical solutions in the embodiments of the present disclosure.

1-10. (canceled)

11. A method for controlling a self-cleaning maintenance station, wherein the self-cleaning maintenance station comprises a clean water tank, a wastewater tank, and a cleaning tank, and the method comprises:
acquiring a self-cleaning maintenance station emptying instruction triggered by a user, and stopping injecting clean water into the clean water tank; and
executing a drainage operation instruction within a first preset time range, wherein the drainage operation instruction comprises: causing a clean water pump to pump the clean water from the clean water tank to the cleaning tank, causing a wastewater pump to pump wastewater from the cleaning tank to the wastewater tank, and causing a drainage pump to drain the wastewater from the wastewater tank by a drainage pump.

12. The method according to claim 11, further comprising:
stopping the clean water pump from pumping the water from the clean water tank and stopping the wastewater pump from suctioning the wastewater from the cleaning tank in response to determining that a wastewater tank full instruction is triggered within the first preset time range; and
continuing to cause the drainage pump to drain the wastewater from the wastewater tank within a second preset time range.

13. The method according to claim 12, further comprising:
continuing to execute the drainage operation instruction in response to determining that the wastewater tank full instruction is not triggered; and
triggering a wastewater tank error instruction in response to determining that the wastewater tank full instruction is still triggered.

14. The method according to claim 11, further comprising:
stopping the clean water pump from pumping the water from the clean water tank in response to determining that a cleaning tank full instruction is triggered within the first preset time range; and
continuing to cause the wastewater pump to suction the wastewater from the cleaning tank and continuing to cause the drainage pump to drain the wastewater from the wastewater tank within a third preset time range.

15. The method according to claim 14, further comprising:
continuing to execute the drainage operation instruction in response to determining that the cleaning tank full instruction is not triggered; and
triggering a cleaning tank error instruction in response to determining that the cleaning tank full instruction is still triggered.

16. The method according to claim 11, further comprising:
triggering a clean water tank error instruction in response to determining that a clean water tank full instruction is triggered after the first preset time.

17. The method according to claim 11, further comprising:
executing an emptying operation instruction within a fourth preset time range, wherein the emptying operation instruction comprises: stopping a clean water pumping operation of the clean water pump, stopping a wastewater suctioning operation of the wastewater pump, and continuing to cause the drainage pump to drain the wastewater from the wastewater tank.

18. A self-cleaning maintenance station, comprising a processor and a memory, wherein the self-cleaning maintenance station further comprises a clean water tank, a wastewater tank, and a cleaning tank, the memory stores computer program instructions executable by the processor, and the processor, when executing the computer program instructions, is caused to:
acquire a self-cleaning maintenance station emptying instruction triggered by a user, and stop injecting clean water into the clean water tank; and
execute a drainage operation instruction within a first preset time range, wherein the drainage operation instruction comprises: causing a clean water pump to pump the clean water from the clean water tank to the cleaning tank, causing a wastewater pump to pump wastewater from the cleaning tank to the wastewater tank, and causing a drainage pump to drain the wastewater from the wastewater tank by a drainage pump.

19. A non-transitory computer-readable storage medium, storing computer program instructions, wherein the computer program instructions, when loaded and executed by a processor, cause the processor to perform steps of a method for controlling a self-cleaning maintenance station, wherein the self-cleaning maintenance station comprises a clean water tank, a wastewater tank, and a cleaning tank, and the method comprises:
acquiring a self-cleaning maintenance station emptying instruction triggered by a user, and stopping injecting clean water into the clean water tank; and
executing a drainage operation instruction within a first preset time range, wherein the drainage operation instruction comprises: causing a clean water pump to pump the clean water from the clean water tank to the cleaning tank, causing a wastewater pump to pump wastewater from the cleaning tank to the wastewater tank, and causing a drainage pump to drain the wastewater from the wastewater tank by a drainage pump.

20. The self-cleaning maintenance station according to claim 18, wherein the processor is further caused to:
stop the clean water pump from pumping the water from the clean water tank and stop the wastewater pump from suctioning the wastewater from the cleaning tank in response to determining that a wastewater tank full instruction is triggered within the first preset time range; and
continue to cause the drainage pump to drain the wastewater from the wastewater tank within a second preset time range.

21. The self-cleaning maintenance station according to claim 20, wherein the processor is further caused to:
continue to execute the drainage operation instruction in response to determining that the wastewater tank full instruction is not triggered; and
trigger a wastewater tank error instruction in response to determining that the wastewater tank full instruction is still triggered.

22. The self-cleaning maintenance station according to claim 18, wherein the processor is further caused to:
stop the clean water pump from pumping the water from the clean water tank in response to determining that a cleaning tank full instruction is triggered within the first preset time range; and
continue to cause the wastewater pump to suction the wastewater from the cleaning tank and continue to cause the drainage pump to drain the wastewater from the wastewater tank within a third preset time range.

23. The self-cleaning maintenance station according to claim 22, wherein the processor is further caused to:
continue to execute the drainage operation instruction in response to determining that the cleaning tank full instruction is not triggered; and
trigger a cleaning tank error instruction in response to determining that the cleaning tank full instruction is still triggered.

24. The self-cleaning maintenance station according to claim 18, wherein the processor is further caused to:
trigger a clean water tank error instruction in response to determining that a clean water tank full instruction is triggered after the first preset time.

25. The self-cleaning maintenance station according to claim 18, wherein the processor is further caused to:
execute an emptying operation instruction within a fourth preset time range, wherein the emptying operation instruction comprises: stopping a clean water pumping operation of the clean water pump, stopping a wastewater suctioning operation of the wastewater pump, and continuing to cause the drainage pump to drain the wastewater from the wastewater tank.

26. The non-transitory computer-readable storage medium according to claim 19, wherein the method further comprises:
stopping the clean water pump from pumping the water from the clean water tank and stopping the wastewater pump from suctioning the wastewater from the cleaning tank in response to determining that a wastewater tank full instruction is triggered within the first preset time range; and
continuing to cause the drainage pump to drain the wastewater from the wastewater tank within a second preset time range.

27. The non-transitory computer-readable storage medium according to claim 19, wherein the method further comprises:
stopping the clean water pump from pumping the water from the clean water tank in response to determining that a cleaning tank full instruction is triggered within the first preset time range; and
continuing to cause the wastewater pump to suction the wastewater from the cleaning tank and continuing to cause the drainage pump to drain the wastewater from the wastewater tank within a third preset time range.

28. The non-transitory computer-readable storage medium according to claim 27, wherein the method further comprises:
continuing to execute the drainage operation instruction in response to determining that the cleaning tank full instruction is not triggered; and
triggering a cleaning tank error instruction in response to determining that the cleaning tank full instruction is still triggered.

29. The non-transitory computer-readable storage medium according to claim 19, wherein the method further comprises:
triggering a clean water tank error instruction in response to determining that a clean water tank full instruction is triggered after the first preset time.

30. The non-transitory computer-readable storage medium according to claim 19, wherein the method further comprises:
executing an emptying operation instruction within a fourth preset time range, wherein the emptying operation instruction comprises: stopping a clean water pumping operation of the clean water pump, stopping a wastewater suctioning operation of the wastewater pump, and continuing to cause the drainage pump to drain the wastewater from the wastewater tank.
